(19) United States
(12) Patent Application Publication
(10) Pub. No.: US 2017/0014757 A1
(43) Pub. Date: Jan. 19, 2017

(54) Plasma filtration device

(71) Applicant: Clean Station Technology Co., Ltd., Taipei (TW)

(72) Inventors: An-Hsin Lin, Taipei (TW); Chung-Ming Liu, Taipei (TW); Yasushi NISHIDA, Taipei (TW); Wei Sung, Taipei (TW); Feng-Pin Wu, Taipei (TW); Yu-Lien Hu, Taipei (TW)

(73) Assignee: Clean Station Technology Co., Ltd., Taipei (TW)

(21) Appl. No.: 15/204,803

(22) Filed: Jul. 7, 2016

(30) Foreign Application Priority Data
Jul. 16, 2015 (TW) 104123013
Jun. 30, 2016 (CN) 201610507494.1

(51) Int. Cl. B01D 53/32; B01J 19/08; B01D 46/00

(52) U.S. Cl. CPC B01D 53/32; B01D 46/0032; B01D 46/0027; B01D 46/0023; B01J 19/087; B01D 2259/818; B01D 2279/40; B01J 2219/0803

(57) ABSTRACT

A plasma filtration device has a plasma module and a filter. The filter is mounted outside of the outlet side of the plasma module. A high-electric field is formed in the plasma module to excite the air to enter a plasma state so that the structures of the hazardous substances are damaged to dissociate into cations and anions. Since the hazardous substances are damaged, the hazardous substances do not harm the users. Further, since the filter is mounted outside of the plasma filtration module, the particles blocked on the filter do not be effected by the electric fields and do not generate the undesired ozone and peculiar smell. Thus, the plasma filtration device achieves high efficiency air clean effect while preventing side effects.

### CROSS-REFERENCE TO RELATED APPLICATIONS

This application is based upon and claims priority under 35 U.S.C. 119 from Taiwan Patent Application No. 104123013 filed on Jul. 16, 2015, which is hereby specifically incorporated herein by this reference thereto.

This application is based upon and claims priority under 35 U.S.C. 119 from China Patent Application No. 201610507494.1 filed on Jun. 30, 2016, which is hereby specifically incorporated herein by this reference thereto.

### BACKGROUND OF THE INVENTION

1. Field of the Invention

The present invention relates to a plasma filtration device, especially to a plasma filtration device for filtering air.

2. Description of the Prior Arts

As the development of the industry and the growth of the population, the artificial hazardous substances are getting more and more in the air. Thus, air filtration apparatuses such as air purifiers and air cleaners become necessary for ordinary life to effectively filter air and to keep the hazardous substances such as allergen, dust mites, bacteria, viruses, poisonous gas molecules from harming human bodies. To effectively filter air, conventional air filtration apparatuses use many different means.

With reference to FIGS. 18 and 19, an electrostatic dust-collecting device used in a conventional air filtration apparatus comprises a first filters 40, a second filter 41, multiple conducting plates 60, multiple wires 50 and multiple dust-collecting plates 70. The first and second filters 40, 41 are arranged parallel to each other. The conducting plates 60 are mounted between the filters 40, 41 in parallel, are perpendicular to the filters 40, 41 and electrically connect to a cathode of a power source. Each wire 50 is mounted between two adjacent conducting plates 60 and electrically connect to an anode of the power source so that electric fields are generated respectively between the wires 50 and the conducting plates 60. Generally, the intensity of the electric fields are between 5×10⁴ V/m to 2×10⁵ V/m. The dust-collecting plates 70 are mounted between the filters 40, 41, are arranged respectively in parallel to the conducting plates 60. When the hazardous substances 80 in the air pass through the electric fields, the hazardous substances 80 are affected by the electric fields to become charged substances 81 that carry electric charges. The charged substances 81 are attracted on the dust-collecting plates 70 based on the principle that opposite charges attract each other. Then the clean air passes out through the second filter 41 without the charged substances 81. Therefore, the electrostatic dust-collecting device utilizes the electrostatic force to attract the charged substances 81 on the dust-collecting plates 70. However, the larger hazardous substances are heavier so that the inertial forces are also larger. The inertial force of the larger hazardous substances may be larger then the electrostatic forces so that the larger hazardous substances are not easily attracted on the dust-collecting plates 70. Further, with reference to FIG. 20, since the conducting plates 60 are parallel to the air following direction, the area for the air passing through is smaller. Thus, the possibility for the hazardous substances to become charged substances is also less. Then some of the larger hazardous substances that do not become charged substances are not attracted by the dust-collecting plates 70 and are released into the air.

With reference to FIG. 21, a conventional plasma filtration device used in a conventional air filtration apparatus comprises a first conducting plate 90, a second conducting plate 91, a third conducting plate 92 and a filter 93. The first and second conducting plates 90, 91 electrically connect to a cathode of a power source. The third conducting plate 92 is mounted between the first and second conducting plates 90, 91 and electrically connects to an anode of the power source so that a first high-voltage electric field is generated between the first conducting plate 90 and the third conducting plate 92 and a second high-voltage electric field is generated between the second conducting plate 91 and the third conducting plate 92. The filter 93 is mounted in the second high-voltage electric field to be charged electrostatically. When the hazardous substances 80 pass through the first high-voltage filed, the hazardous substances 80 are excited to enter a plasma state so that the structures of the hazardous substances 80 are damaged to dissociate into cations and anions. Then the cations, the anions and other substances are attracted on the electrostatic filter 93 in the second high-voltage electric field so that the clean air passes out without the hazardous substances 80. However, the filter 93 is located in the second high-voltage electric field over a long period of time, the cations, the anions and other substances attracted on the filter 93 may cause point discharge by the effect of the second high-voltage field to further generate peculiar smell and to increase the possibility to generate the ozone. When concentration of the ozone reaches 0.1 mg/m³, the respiratory passages of users may be irritated. When the concentration of the ozone reaches 2 mg/m³, the illness such as headache, chest pain and so on may be caused. Therefore, the generation of the ozone for the conventional plasma filtration device is uncontrollable side effect and is inconvenient for the users.

To overcome the shortcomings, the present invention provides a plasma filtration device to mitigate or obviate the aforementioned problems.

### SUMMARY OF THE INVENTION

The main objective of present invention is to provide a plasma filtration device that prevents the generation of the ozone and to enhance the filtering efficiency. The plasma filtration device has a plasma module and a filter. The filter is mounted outside of the outlet side of the plasma module. A high-electric field is formed in the plasma module to excite the air to enter a plasma state so that the structures of the hazardous substances are damaged to dissociate into cations and anions. Since the hazardous substances are damaged, the hazardous substances do not harm the users. Further, since the filter is mounted outside of the plasma filtration module, the particles blocked on the filter do not be effected by the electric fields and do not generate the undesired ozone and peculiar smell. Thus, the plasma filtration device achieves high efficiency air clean effect while preventing side effects.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a plasma filtration device in accordance with the present invention;

FIG. 2 is an exploded perspective view of the plasma filtration device in FIG. 1;

FIG. 3 is an operational side view in partial section of the plasma filtration device in FIG. 1;

FIG. 4 is an enlarged illustrative view of the plasma filtration device in FIG. 1, showing the electric field;

FIG. 5 is a perspective view of a second embodiment of a plasma filtration device in accordance with the present invention;

FIG. 6 is an exploded perspective view of the plasma filtration device in FIG. 5;

FIG. 7 is an operational side view in partial section of the plasma filtration device in FIG. 5;

FIG. 8 is an exploded perspective view of a third embodiment of a plasma filtration device in accordance with the present invention;

FIG. 9 is an operational side view in partial section of the plasma filtration device in FIG. 8;

FIG. 10 is an exploded perspective view of a fourth embodiment of a plasma filtration device in accordance with the present invention;

FIG. 11 is an exploded perspective view of a fifth embodiment of a plasma filtration device in accordance with the present invention;

FIG. 12 is an operational side view in partial section of the plasma filtration device in FIG. 11;

FIG. 13 is exploded perspective view of a sixth embodiment of a plasma filtration device in accordance with the present invention;

FIG. 14 is an partially enlarged side view in partial section of the plasma filtration device in FIG. 5;

FIG. 15 is perspective view of a conducting sheet of a seventh embodiment of a plasma filtration device in accordance with the present invention;

FIG. 16 is a partially enlarged side view of the plasma filtration device in FIG. 15;

FIG. 17 is an partially enlarged top view in partial section of the plasma filtration device in FIG. 5;

FIG. 18 is an exploded perspective view of an electrostatic dust-collecting device in accordance with the prior art;

FIG. 19 is an operational side view in partial section of the electrostatic dust-collecting device in FIG. 18;

FIG. 20 enlarged illustrative view of the electrostatic dust-collecting device in FIG. 18, showing the electric field; and

FIG. 21 is an operational side view in partial section of a conventional plasma filtration device in accordance with the prior art.

### DETAILED DESCRIPTION OF THE EMBODIMENTS

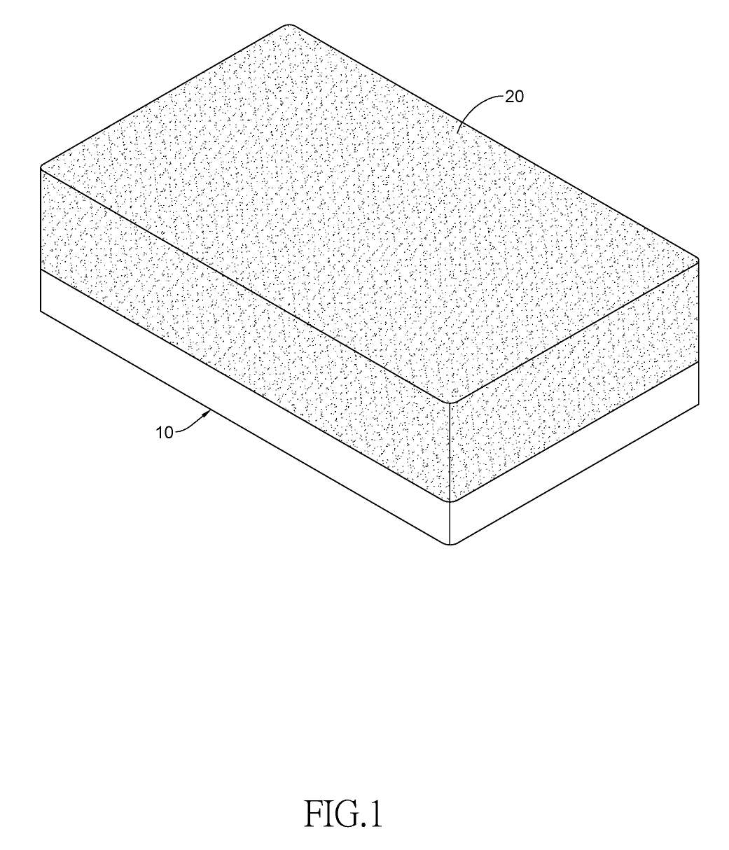

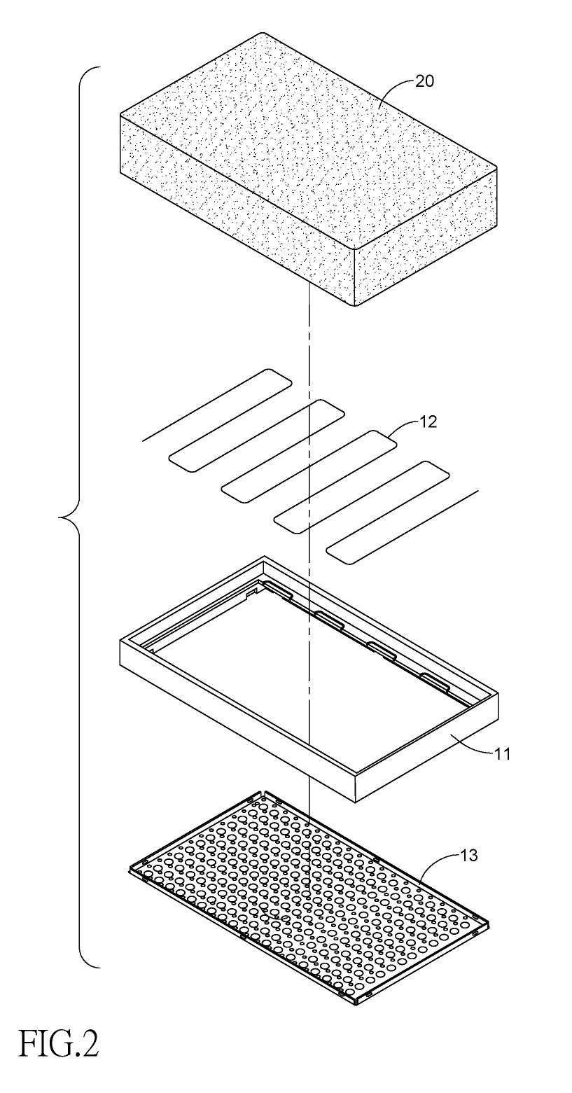

With reference FIGS. 1 to 3, a plasma filtration device in accordance with the present invention comprises a first plasma module 10 and a first filter 20.

The first plasma module 10 comprises an outer frame 11, an inlet side, an outlet side, a first conducting net 12 and a first conducting plate 13. The first conducting net 12 and the first conducting plate 13 are attached to the outer frame 11 in an interval. The first conducting net 12 is adjacent to the outlet side. The first conducting plate 13 is mounted across the inlet side so that the air flowing direction is perpendicular to the first conducting plate 13. A high-voltage electric field is formed between the first conducting net 12 and the first conducting plate 13 and may have an intensity of 7×10⁵ V/m to 3×10⁶ V/m. The first conducting net 12 may electrically connect to an anode of a high-voltage power source while the first conducting plate 13 may electrically connect to a cathode of the high-voltage power source. The voltage supplied to the first conducting net 12 may be 6.5 to 7.5 kV. A distance between the first conducting net 12 and the first conducting plate 13 may be in a range of 10 to 20 mm.

The first filter 20 is mounted outside of the outlet side of the first plasma module 10 and may be an electrostatic charged filter.

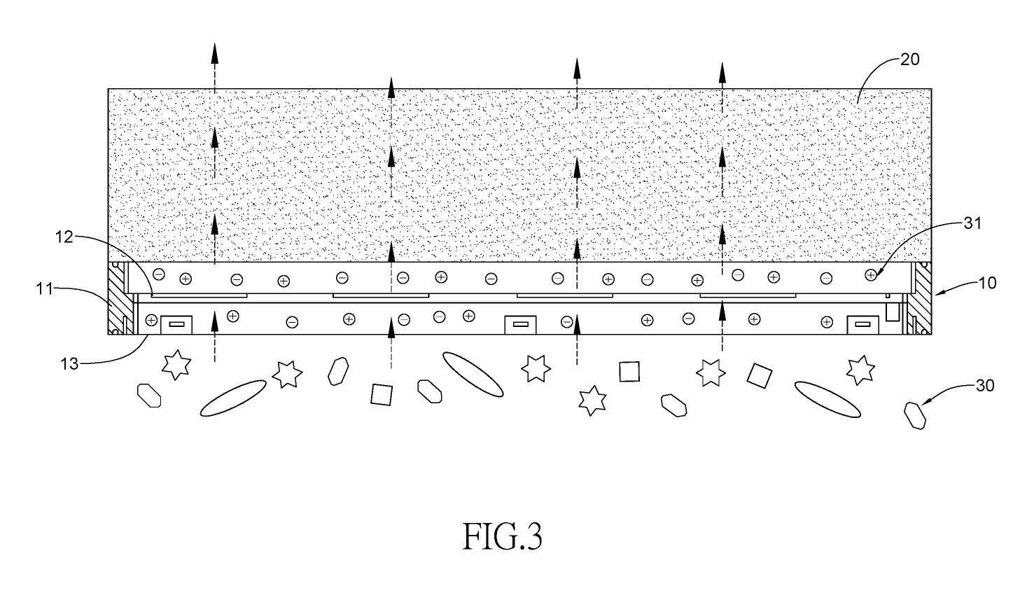

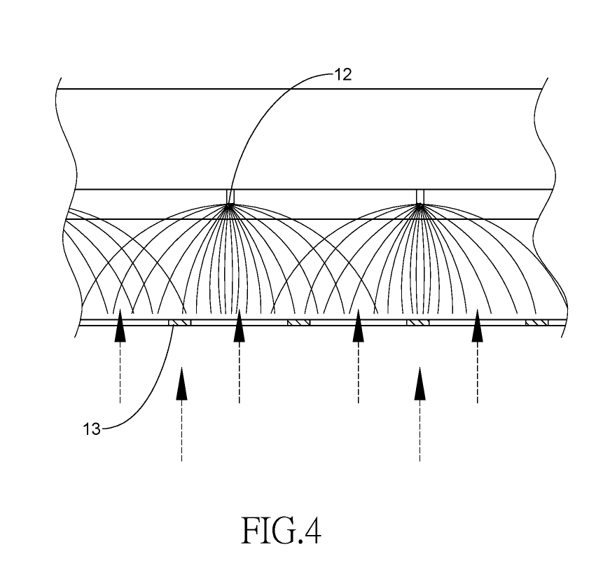

With reference to FIG. 3, when the air flows into the inlet side of the first plasma module 10, the hazardous substances 30 also flow into the first plasma module 10. Since the intensity of the high-voltage electric field is large enough to excite the air to enter the plasma state so that the structures of the hazardous substances 30 are damaged to dissociate into cations and anions 31. If the air contains organism such as dust mites, bacteria and so on, the cell walls are broken in high-voltage electric field so that the organism loses its original harmfulness. If the air contains poisonous gas molecules with peculiar smell or toxicity, the molecular bond is also broken in high-voltage electric field so that the poisonous gas molecules also lose their original harmfulness. Thus, the air flowing out of the outlet side of the first plasma module 10 is harmless and odorless. When the air flows through the first filter 20, the cations and anions 31 and other particles are blocked on the filter 20, especially when the filter 20 is the electrostatic charged filter, the cations and anions 31 are attracted on the electrostatic charged filter. Therefore, the air flowing out of the filter 20 is effectively filtered without the hazardous substances 30. In addition, since the filter 20 is mounted outside of the plasma filtration module 10, the particles blocked on the filter 20 do not be effected by the electric fields and do not generate the undesired ozone and peculiar smell. Further, with reference to FIG. 4, since the first conducting plate 13 is mounted across the inlet side to be perpendicular to the air flow, the contact area of the high-voltage electric field and the air flow is increased to prolong the time that the hazardous substances 30 pass through the high-voltage electric field. Thus, the hazardous substances 30 is ensured to be damaged.

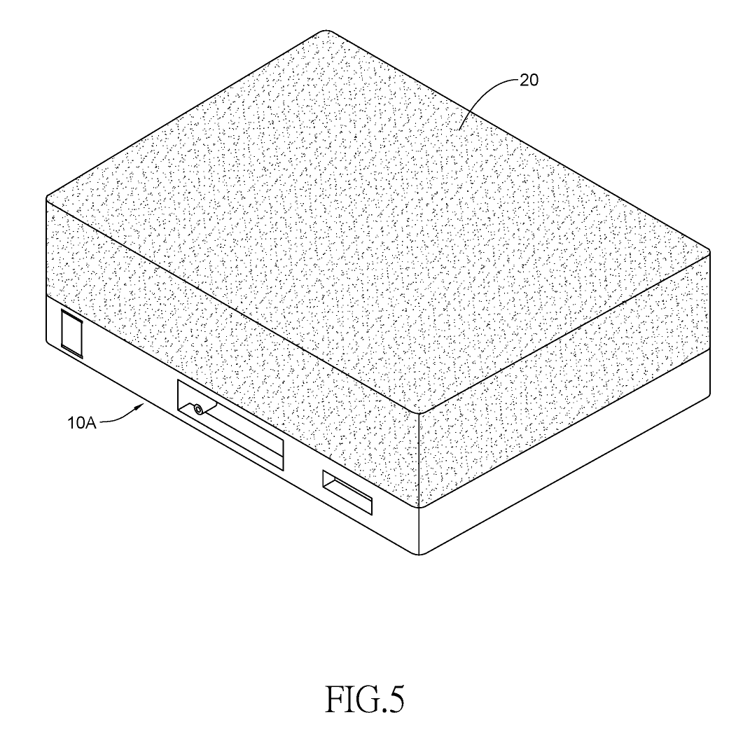

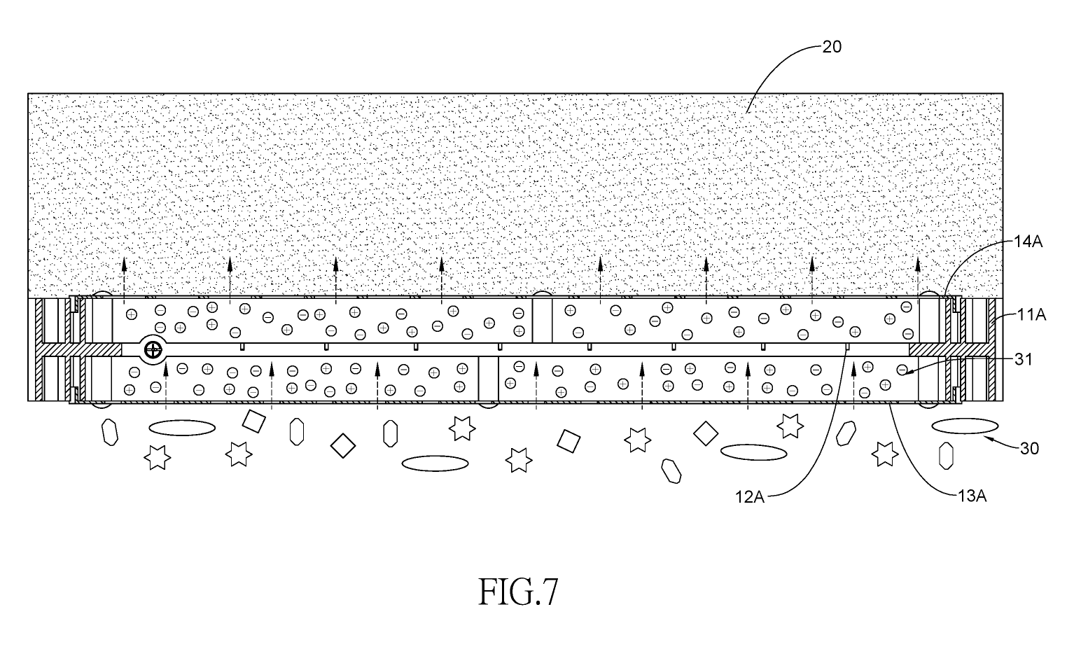

With reference to FIGS. 5 to 7, in one embodiment, the first plasma module 10A of the plasma filtration device in accordance with the present invention comprises the outer frame 11A, the first conducting net 12A, the first conducting plate 13A and a second conducting plate 14A. The second conducting plate 14A is mounted across the outlet side of the first plasma module 10A and is parallel to the first conducting plate 13A. The first conducting net 12A is mounted between the first conducting plate 13A and the second conducting plate 14A. A high electric field is formed between the first conducting net 12A and the first conducting plate 13A, and another high electric field is formed between the first conducting net 12A and the second conducting plate 14A. With the dual-high voltage electric fields, the hazardous substances passing through the dual-high voltage electric fields are ensured to be damaged.

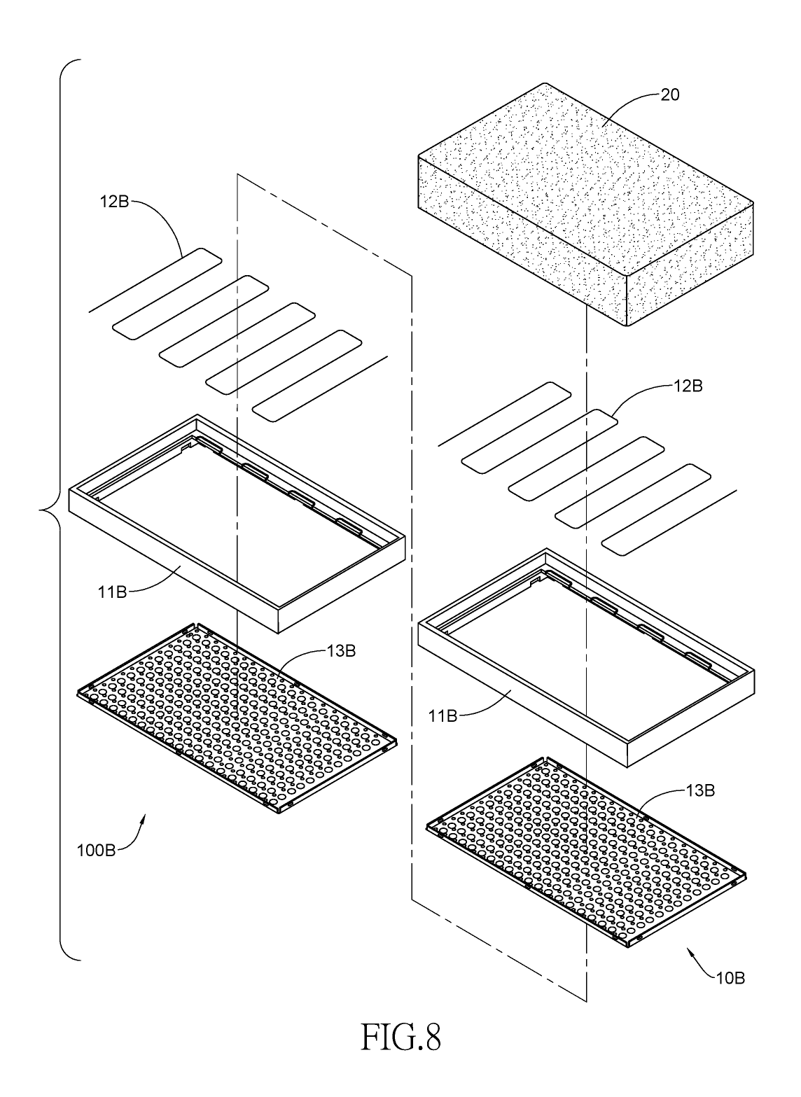

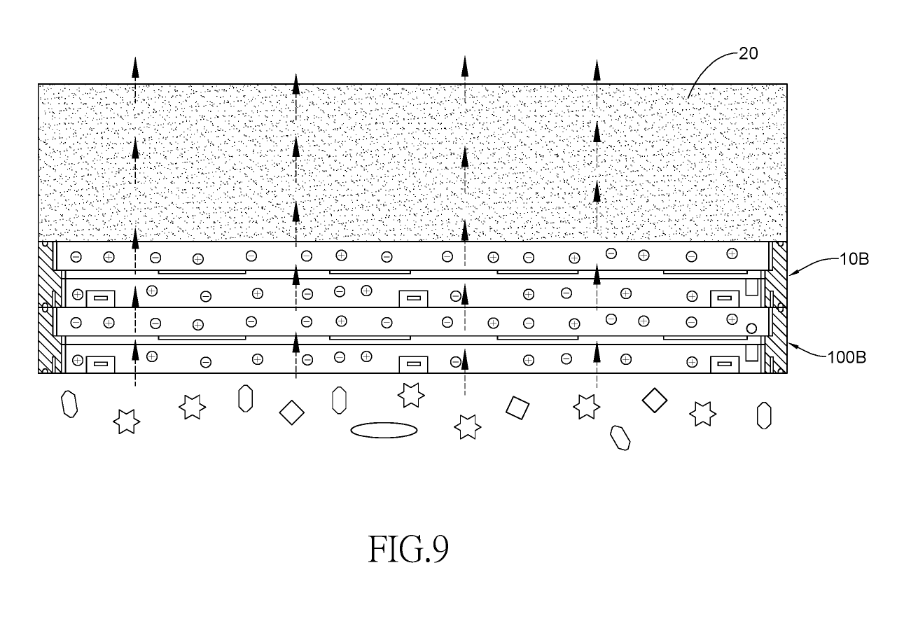

With reference to FIGS. 8 and 9, in one embodiment, a plasma filtration device in accordance with the present invention comprises the first plasma module 10B and a second plasma module 100B. The first plasma module 10B and the second plasma module 100B are stacked and are parallel with each other. The inlet side of the first plasma module 1 OB communicates with the outlet side of the second plasma module 100B. Each plasma module 10B, 100B has the inlet side, the outlet side, the outer frame 11B, the first conducting net 12B and the first conducting plate 13B. Between the first conducting net 12B and the first conducting plate 13B of each plasma module 10B, 100B, a high-voltage electric field is formed so that the plasma filtration as shown in FIGS. 8 and 9 provides dual-high voltage electric fields. With the dual-high voltage electric fields, the hazardous substances passing through the dual-high voltage electric fields are ensured to be damaged.

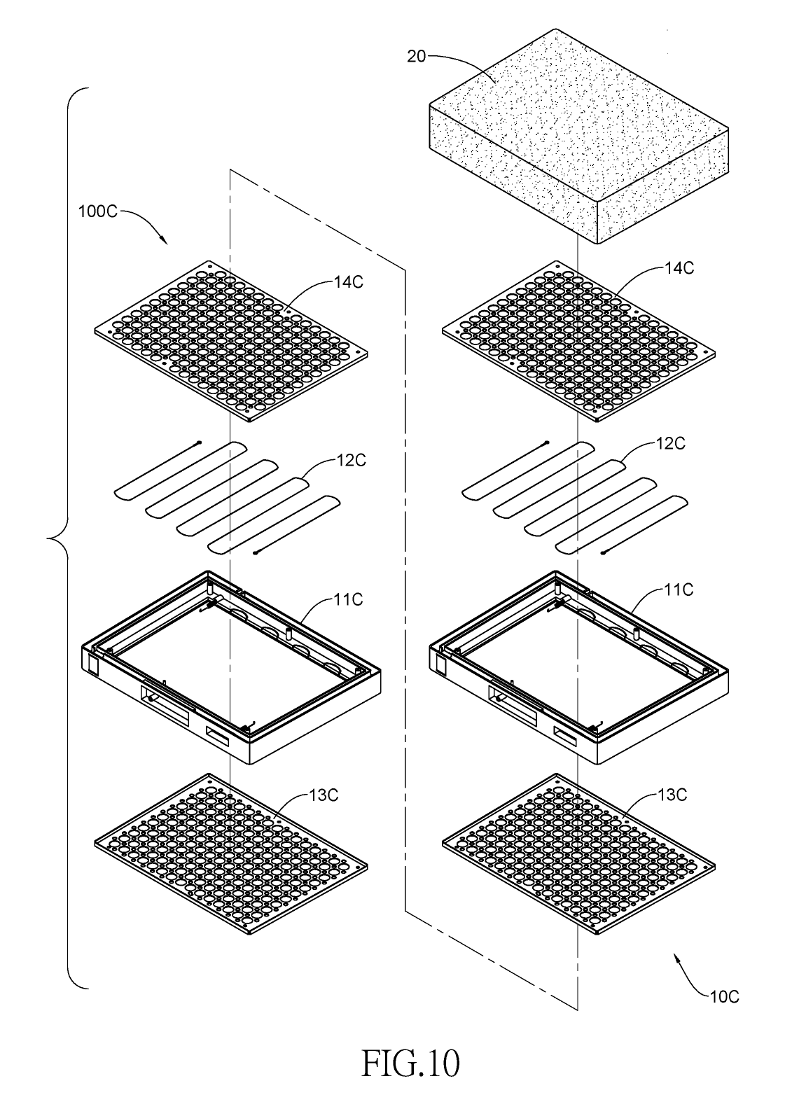

With reference to FIG. 10, in one embodiment, a plasma filtration device in accordance with the present invention comprises the first plasma module 10C and a second plasma module 100C. The first plasma module 10C and the second plasma module 100C are stacked and are parallel with each other. Each plasma module 10C, 100C has the inlet side, the outlet side, the outer frame 11C, the first conducting net 12C, the first conducting plate 13C and the second conducting plate 14C. For each plasma module 10C, 100C, the first conducting net 12C is mounted between the first conducting plate 13C and the second conducting plate 14C. Between the first conducting net 12C and the first conducting plate 13C of each plasma module 10C, 100C, a high-voltage electric field is formed. Between the first conducting net 12C and the second conducting plate 14C of each plasma module 10C, 100C, a high-voltage electric field is formed. Thus, the plasma filtration as shown in FIG. 10 provides four high voltage electric fields. With the multi-high voltage electric fields, the hazardous substances passing through the dual-high voltage electric fields are ensured to be damaged.

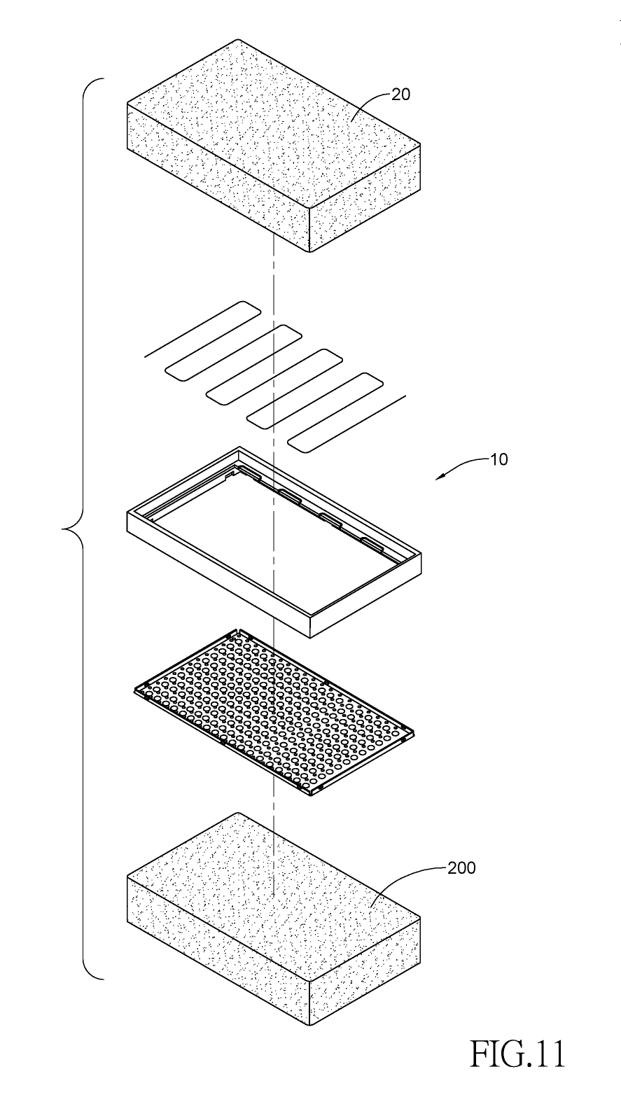

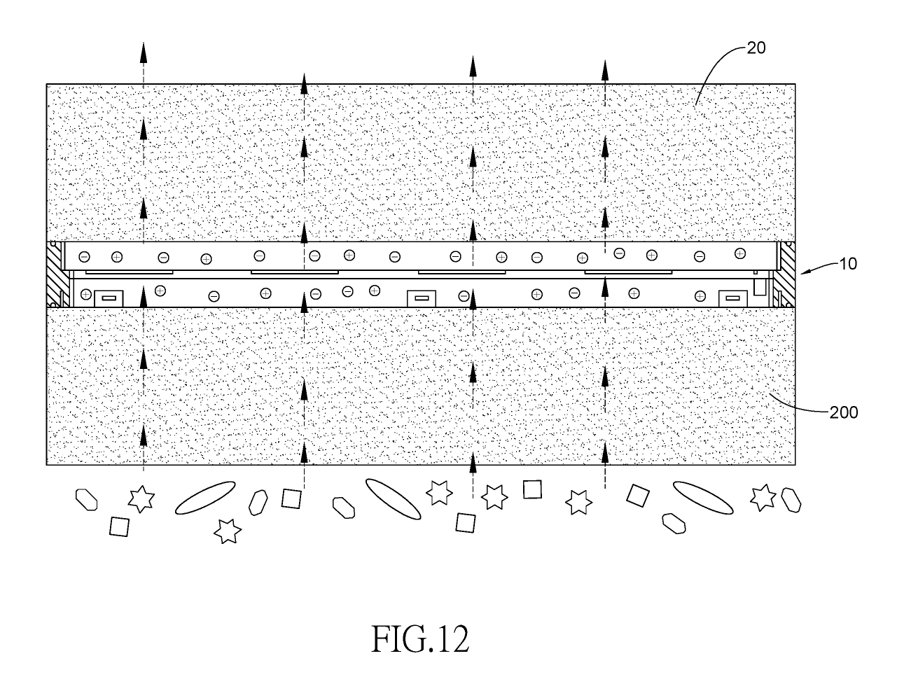

With reference to FIGS. 11 to 13, in one embodiment, a plasma filtration device in accordance with the present invention comprises a first filter 20 and a second filter 200. The first filter 20 is mounted outside of the outlet side of the first plasma module 10, 10A. The second filter 200 is mounted outside of the inlet side of the first plasma module 10, 10A. Therefore, the air flows through the second filter 200, the first plasma module 10, 10A and the first filter 20 in sequence so that the substances with larger particles are blocked in the second filter 200 first. Thus, the filtration effect is further enhanced. Moreover, the plasma filtration device as described may comprise the first plasma module and the second plasma module and the second filter is mounted outside of the inlet side of the second plasma module and the first filter is mounted outside of the outlet side of the first plasma module.

In conclusion, the plasma filtration device as described may have one or more plasma filtration modules and one or more filters. The plasma filtration modules may have one or two conducting plates to form one or two high-voltage electric fields. The high-voltage electric fields excite the air to enter the plasma state so that the structures of the hazardous substances are damaged to dissociate into cations and anions. Then the filters blocks the cations and anions and other particles to effectively filter the air and to provide clean air.

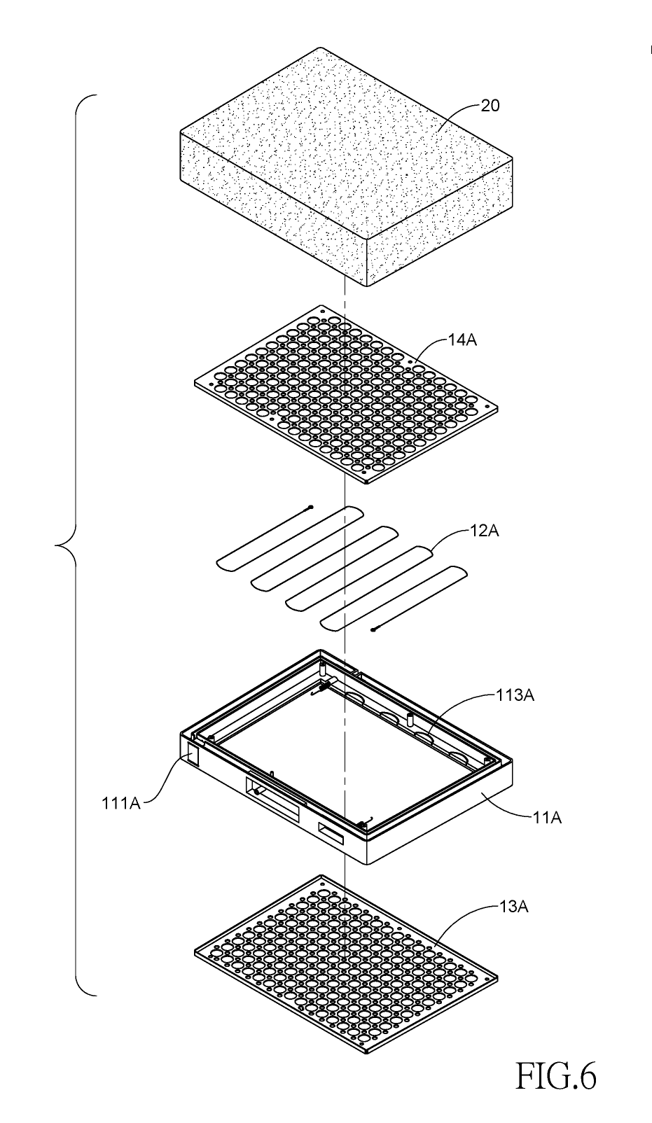

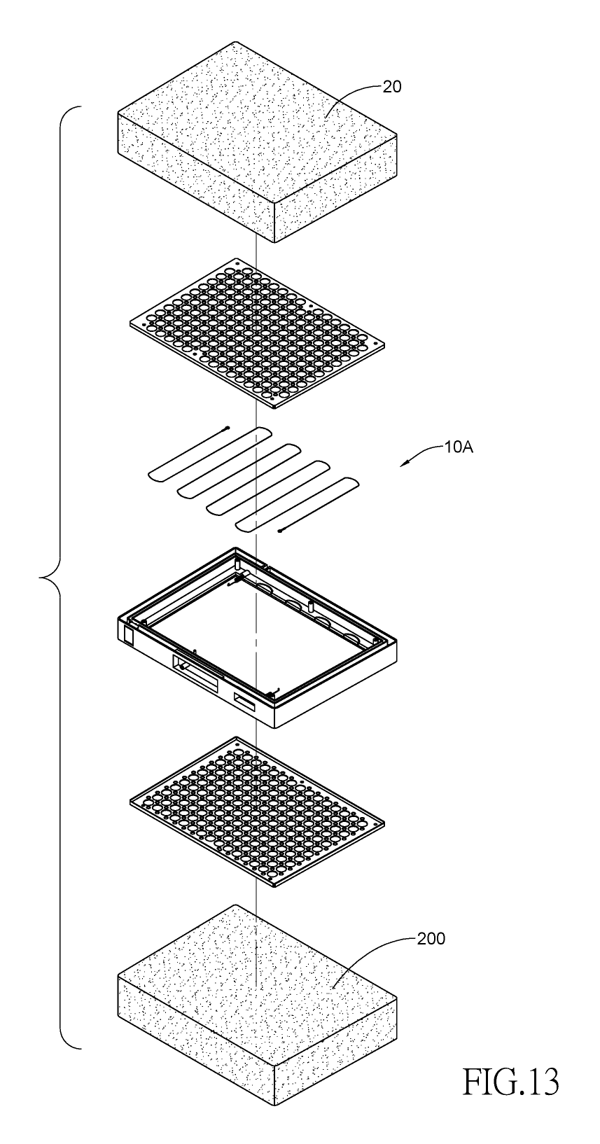

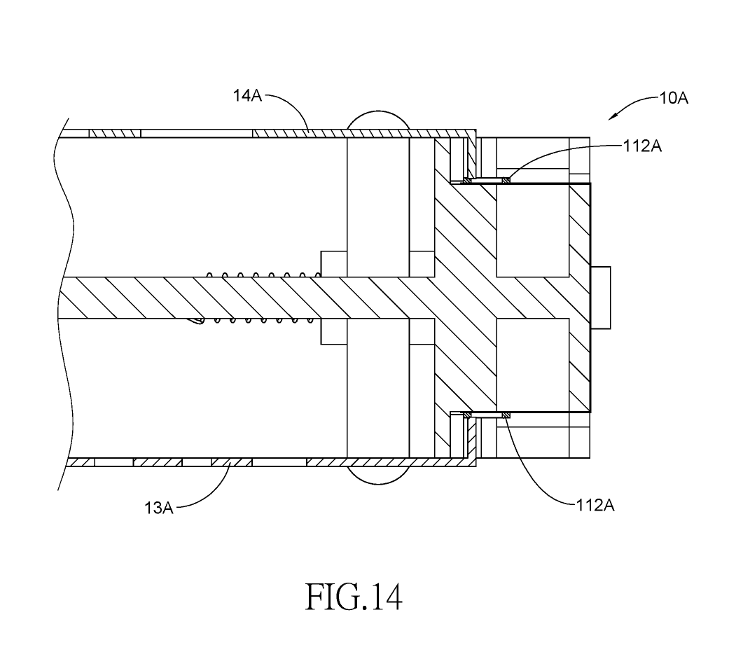

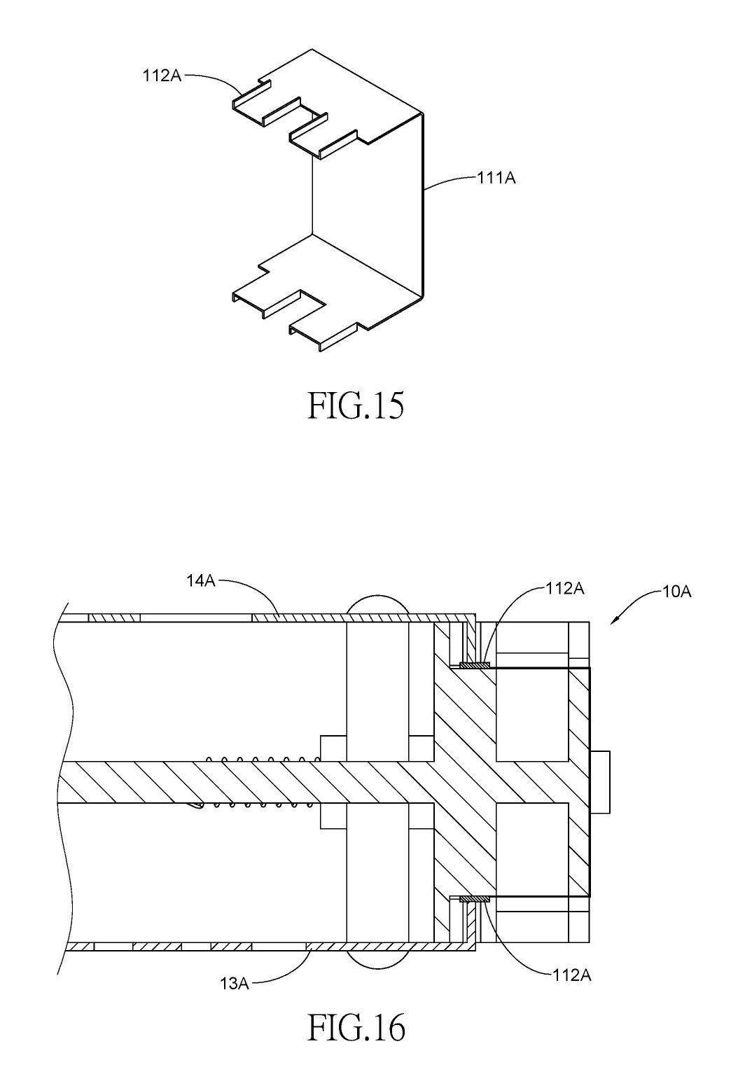

In addition, with reference to FIGS. 6 and 14, in one embodiment, the electric current is conducted in to the first conducting plate 13A and the second conducting plate 14A through two conducting pads 112A mounted on a conducting sheet 111A. The first conducting pads 112A respectively abut tightly against the first conducting plate 13A and the second conducting plate 14A to electrically connect the first conducting pads 112A respectively to the first conducting plate 13A and the second conducting plate 14A so that the electricity conduction effect is enhanced. In another embodiment shown in FIGS. 15 and 16, an end of each conducting sheet 11A is bent to form at least one protrusion 112A to electrically connect to the surfaces of the first conducting plate 13A and the second conducting plate 14A so that the electricity conduction effect is enhanced.

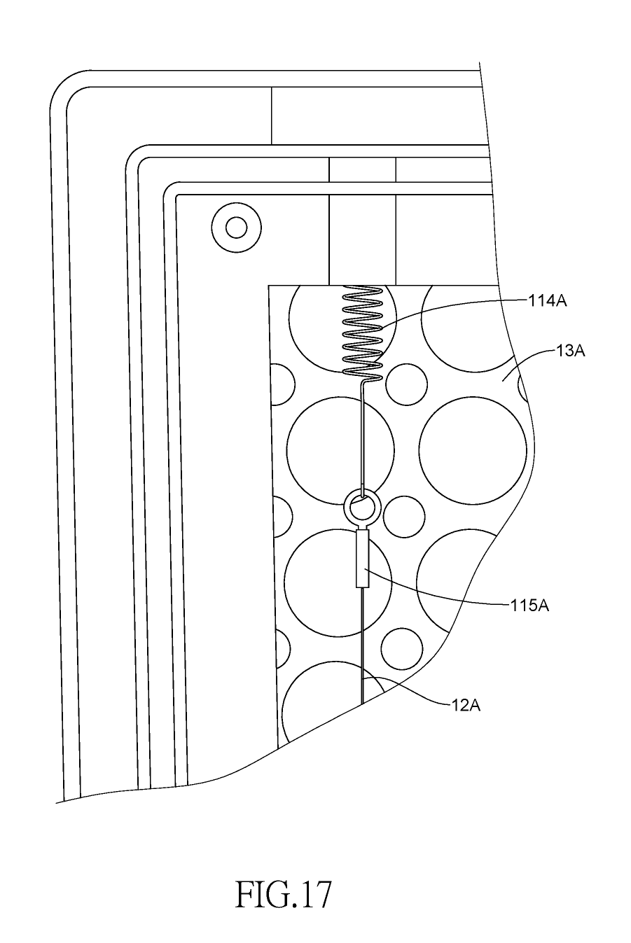

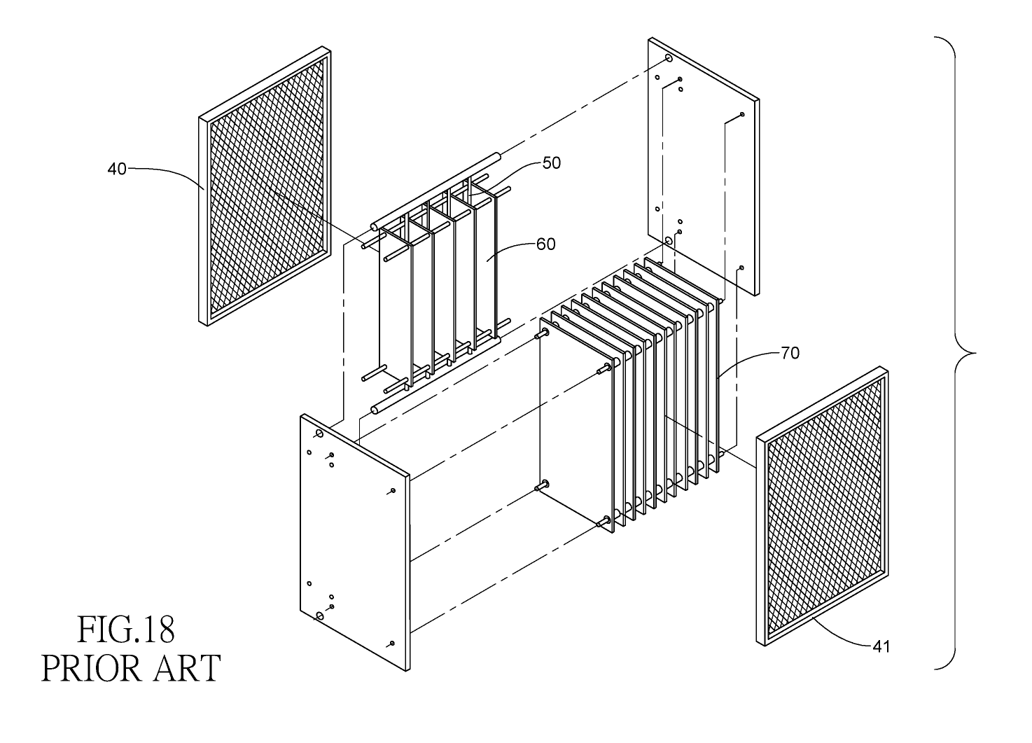

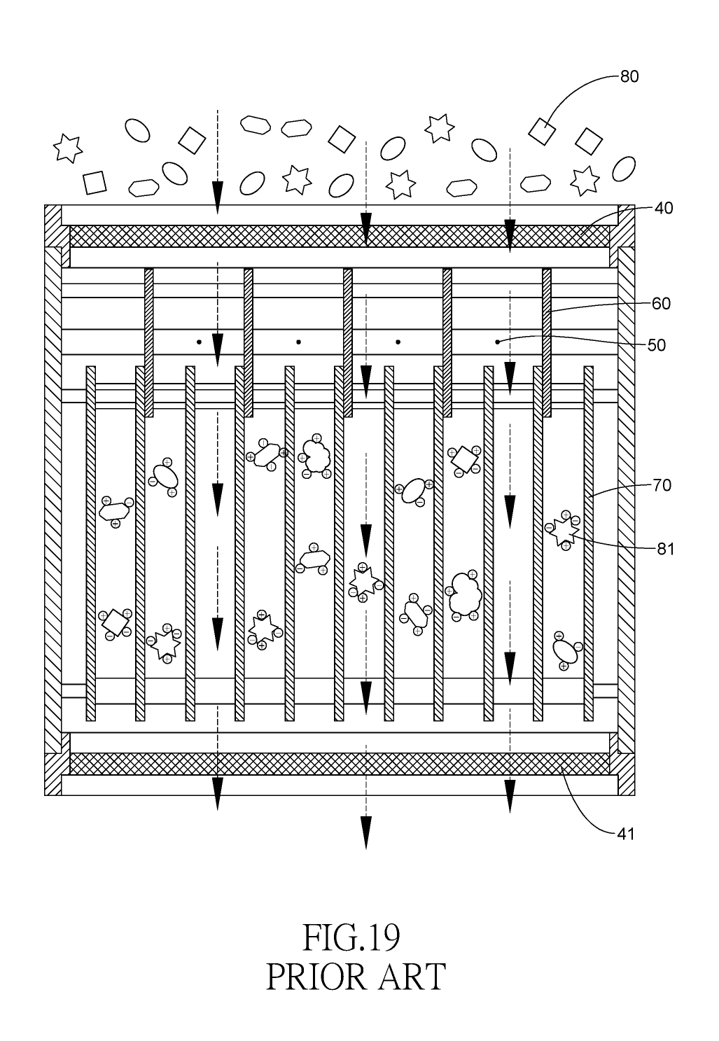

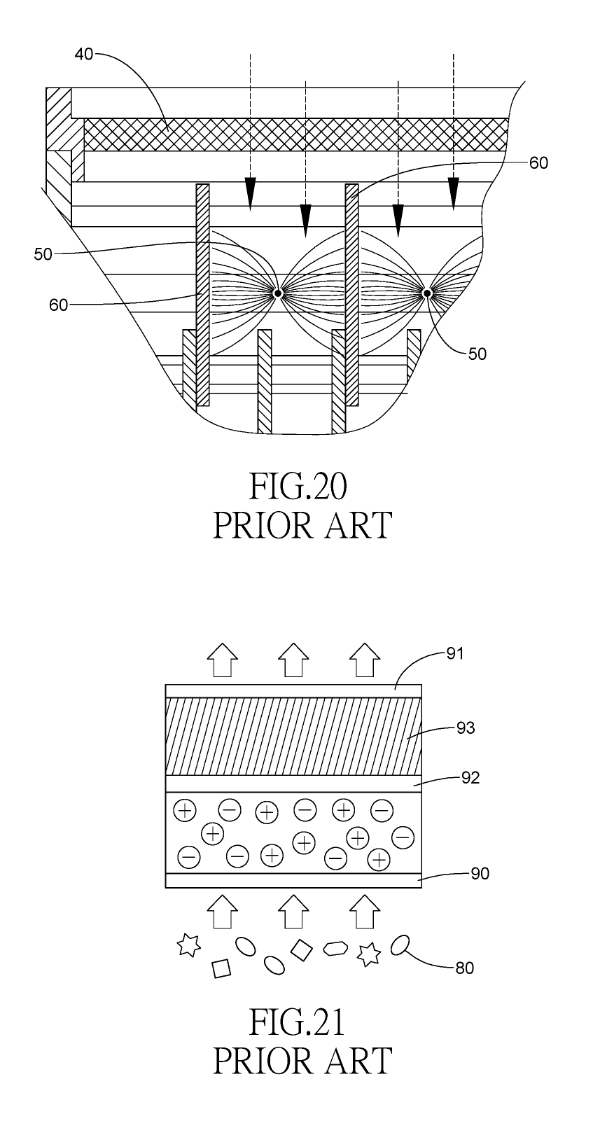

In addition, with reference to FIGS. 6 and 17, the frame 11A has multiple dents 113A formed thereon. The first conducting net 12A is wound though the dents 113A to form the net-shape and two ends of the first conducting net 12A connect securely to the frame 11A. To prevent the first conducting net 12A from shaking because of the air flow to cause the short by the conducting net 12A contacting to the first conducting plate 13A, the two ends of the first conducting net 12A connect securely to the frame 11A through the springs 114A. Then the first conducting net 12A is tightened so that the elasticity of the spring absorbs the impact of the air flow to keep the first conducting net 12 from shaking. Further, since the point discharge may generate the ozone or other unfavorable phenomenon, a insulating protecting sleeve 115A may be mounted around each end of the first conducting net 12A to keep the ends of the first conducting net 12A from generating point discharge.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A plasma filtration device comprising:
a first plasma module having
an inlet side;
an outlet side;
an outer frame;
a first conducting net attached to the outer frame;
a first conducting plate attached to the outer frame and being in an interval with the first conducting net; and
a high-voltage electric field formed between the first conducting net and the first conducting plate; and
a first filter mounted outside of the outlet side of the first plasma module.

2. The plasma filtration device as claimed in claim 1, wherein the first plasma module further comprises
a second conducting plate attached to the outer frame and being parallel to the first conducting plate so that the first conducting net is mounted between the first conducting plate and the second conducting plate; and
a high-voltage electric field formed between the first conducting net and the second conducting plate.

3. The plasma filtration device as claimed in claim 1 further comprising a second plasma module having the same structure with and stacked in parallel to the first plasma module, wherein the inlet side of the first plasma module communicates with the outlet side of the second plasma module.

4. The plasma filtration device as claimed in claim 2 further comprising a second plasma module having the same structure with and stacked in parallel to the first plasma module, wherein the inlet side of the first plasma module communicates with the outlet side of the second plasma module.

5. The plasma filtration device as claimed in claim 1 further comprising a second filter mounted outside of the inlet side of the first plasma module.

6. The plasma filtration device as claimed in claim 2 further comprising a second filter mounted outside of the inlet side of the first plasma module.

7. The plasma filtration device as claimed in claim 3 further comprising a second filter mounted outside of the inlet side of the second plasma module.

8. The plasma filtration device as claimed in claim 4 further comprising a second filter mounted outside of the inlet side of the second plasma module.

9. The plasma filtration device as claimed in claim 1, wherein the first filter is an electrostatic charged filter.

10. The plasma filtration device as claimed in claim 2, wherein the first filter is an electrostatic charged filter.

11. The plasma filtration device as claimed in claim 1, wherein the intensity of the high-voltage electric field is in a range of 7×10⁵ V/m to 3×10⁶ V/m.

12. The plasma filtration device as claimed in claim 2, wherein the intensity of the high-voltage electric field is in a range of 7×10⁵ V/m to 3×10⁶ V/m.

13. The plasma filtration device as claimed in claim 2, wherein the frame has a conducting sheet and two conducting pads attached to the conducting sheet and respectively abutting tightly against and electrically connecting to the first conducting plate and the second conducting plate.

14. The plasma filtration device as claimed in claim 2, wherein the frame has a conducting sheet having an ends bent to form at least one protrusion electrically connecting to the first conducting plate and the second conducting plate.

15. The plasma filtration device as claimed in claim 1, wherein the first conducting plate is mounted across the inlet side.

16. The plasma filtration device as claimed in claim 2, wherein the first conducting plate is mounted across the inlet side.
